(19) United States
(12) Patent Application Publication
(10) Pub. No.: US 2017/0307168 A1
(43) Pub. Date: Oct. 26, 2017

(54) LIGHTING DEVICE COMPRISING TWO ZONES, INTENDED FOR A MOTOR VEHICLE, AND LIGHT EQUIPPED WITH SUCH A LIGHTING DEVICE

(71) Applicant: VALEO VISION, Bobigny Cedex (FR)

(72) Inventors: Pierre ALBOU, Paris (FR); Loic BOINET, Le Mesnil Esnard (FR); Boubacar SAGNA, Sartrouville (FR)

(73) Assignee: VALEO VISION, Bobigny Cedex (FR)

(21) Appl. No.: 15/516,169

(22) PCT Filed: Oct. 2, 2015
(86) PCT No.: PCT/EP2015/072838

§ 371 Date: Mar. 31, 2017

(30) Foreign Application Priority Data
Oct. 2, 2014 (FR) 1459443

(51) Int. Cl. F21S 8/10; B60Q 1/26; F21Y 2115/30

(52) U.S. Cl. CPC F21S 48/234; F21S 48/2212; F21S 48/214; F21S 8/10; B60Q 1/2607; F21Y 2115/30

(57) ABSTRACT

The invention relates to a lighting device comprising two zones, intended in particular for a motor vehicle, including a transmission surface capable of transmitting light rays and at least one light source capable of emitting light rays in order to form a light beam in the direction of the transmission surface. The device also comprises distribution means configured both to distribute the light beam over a first dispersive zone of the transmission surface and to distribute the light beam over a second dispersive zone of the transmission surface, the first dispersive zone being able to transmit the light beam with a first aperture angle and the second dispersive zone being able to transmit the light beam with a second aperture angle.

The present invention relates to a lighting device comprising two zones intended for a motor vehicle and a light, notably a fog light, equipped with such a lighting device.

Motor vehicle lights, generally situated at the rear of the vehicle, are lighting devices that comprise one or more light sources and an outer lens that closes the light. To simplify, the light source emits light rays to form a light beam that is directed toward the outer lens in order to produce a patch of light that transmits light outside the vehicle. The color of the patch of light is characteristic of the function or the type of light. Thus it is known that a white patch of light indicates that the light is a reversing light, that an amber patch of light is a turn indicator, and that a red patch of light is a rear light or a brake light, the brake light being of greater luminous intensity. There also exist red fog lights, the intensity of which is even greater so as to be visible under difficult climatic conditions, such as fog, heavy rain or snow. In addition to the color, these lights have to comply with regulations with regard to intensity and visibility in particular.

The rear of a vehicle therefore includes a plurality of patches of light, each patch of light having a color specific to each function. The light source has a luminous intensity chosen in relation to the type of light. Each of the patches of light being further produced by at least one different light source, the number of lighting devices on the vehicle is increased. The light sources are light-emitting diodes, for example. This large number of light sources impacts on the manufacturing cost of the lights, in particular if the light sources are light-emitting diodes or laser diodes.

The configuration and the positioning of the patches of light can also be limited, some patch of light configurations being difficult to obtain because it is necessary to ensure that the light sources generate the corresponding patch of light without generating a patch of light intended for some other function.

The invention therefore aims to produce a lighting device configured to reduce the number of light sources on a vehicle and to provide new possibilities for the disposition and design of the various lights.

To this end, the invention relates to a lighting device comprising two zones, intended in particular for a motor vehicle, including a transmission surface capable of transmitting light rays and at least one light source capable of emitting light rays in order to form a light beam in the direction of the transmission surface.

The device is remarkable in that it also comprises distribution means configured both to distribute the light beam over a first dispersive zone of the transmission surface and to distribute the light beam over a second dispersive zone of the transmission surface, the first dispersive zone being able to transmit the light beam with a first aperture angle and the second dispersive zone being able to transmit the light beam with a second aperture angle.

The device therefore uses the same light source or sources to light two different dispersive zones. This therefore avoids having to increase the number of light sources for different functions. Indeed, each dispersive zone can fulfil a different function, the distribution means serving to orient the light beam from the light source toward one or the other of the zones.

Moreover, it is easy to arrange the patches of light and to create new light designs thanks to the device, the required positioning of the sources relative to the patches of light causing no problems. The device therefore simplifies the design of the lights.

According to different embodiments of the invention, separately or in combination:
the first aperture angle and the second aperture angle have different values,
the distribution means are configured to distribute the light beam alternately over the first zone and over the second zone at a frequency imperceptible to the eye,
the first disperse zone and/or the second dispersive zone include dispersive patterns,
the dispersive patterns have a cushion shape uniformly distributed over the transmission surface,
the cushions have a curvature,
the curvature of the cushions has a constant radius of curvature.
the cushions of the first and second zones have different radii of curvature,
the first dispersive zone and/or the second dispersive zone include holographic patterns,
the distribution means are means for sweeping the transmission surface configured to sweep the transmission surface with a sweeping amplitude corresponding to the dimensions of the dispersive zone over which the beam is distributed,
the sweeping means include one or two mobile micromirrors configured to sweep the transmission surface with the light beam in a first direction and/or a second direction substantially perpendicular to the first direction,
the light source includes at least one laser diode,
the distribution means consist of a matrix of micromirrors,
the light source includes at least one light-emitting diode,
the light source is of constant intensity,
said device includes an optical system configured to collimate the light rays combining from the light source to form the light beam,
said device includes an outer lens including the transmission surface.

The invention also relates to a light including a lighting device of this kind comprising two zones.

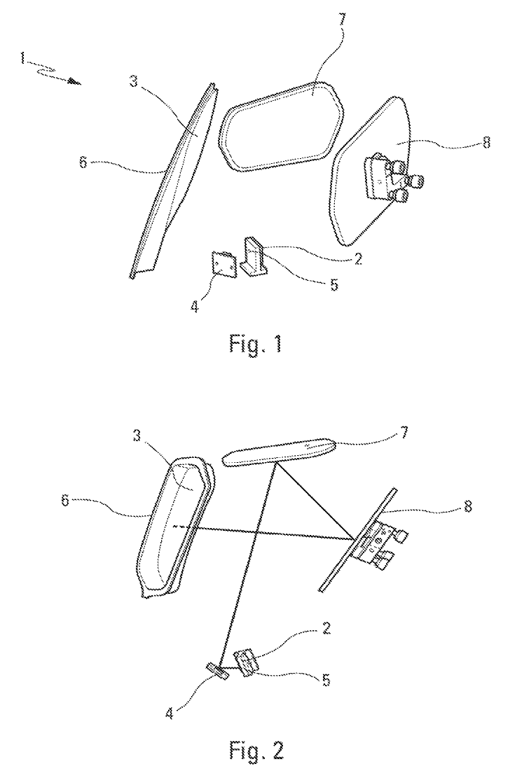

The invention will be better understood in the light of the following description that is given by way of example and not by limitation and is accompanied by the appended drawings:
FIG. 1 is a diagrammati perspective view of one embodiment of a device according to the invention,

FIG. 2 is a diagrammatic top view of the FIG. 1 embodiment,

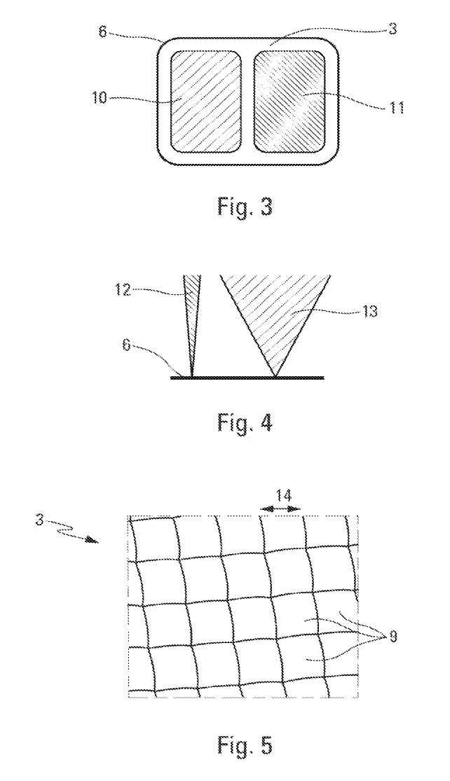

FIG. 3 showing diagrammatically an outer lens with two zones,

FIG. 4 showing diagrammatically the aperture angle of the beams produced by the two zones,

FIG. 5 showing diagrammatically to a larger scale a part of the transmission surface provided with cushions,

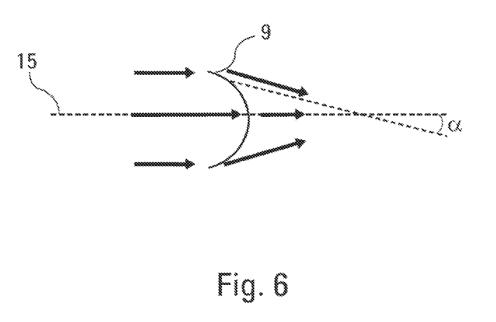

FIG. 6 showing diagrammatically the passage of light rays in a cushion.

FIGS. 1 and 2 show one embodiment of a motor vehicle light, for example a rear light, including a lighting device 1 according to the invention. The lighting device 1 includes a light source 2 adapted to emit light rays to form a light beam and a transmission surface 3 adapted to transmit the light rays. The light source is preferably of constant intensity but may also be of variable intensity depending on the required function of the light.

The transmission surface 3 is for example on the outer lens 6 closing the light. In a first variant, shown in FIGS. 1 and 2, the transmission surface 3 is the inside face of the outer lens 6. It can also be an element separate from the outer lens 6, for example a transmission screen inside the light in front of the outer lens 6. The light beam that issues from the light source 2 is intended to illuminate the transmission surface 3.

In the embodiment from FIGS. 1 and 2, the light source 2 is a laser source comprising a laser diode, for example, emitting radiation at a wavelength is chosen to produce on the outer lens 6 the color corresponding to the function of the light. Alternatively, a wavelength conversion device, for example a phosphor plate, on the path of the light beam converts the wavelength of the laser radiation to produce the required color. The light source 2 can also include an optical device combining a plurality of laser beams into a single beam, for example using optical fibers or devices exploiting different polarizations of different laser sources or dichroic mirrors.

In a second embodiment that is not shown in the figures the light source 2 consists of one or more light-emitting diodes.

In these two embodiments the device 1 includes an optical system 5 configured to collimate the light rays from the source 2 in order to form the light beam. The optical system 5 is a single collimator lens, for example, and can also include a reflector.

Depending on the light source 2 and the optical system 5 chosen, the light beam can project onto the transmission face 3 a light trace in the shape of a spot, a larger patch or even an oblong mark.

According to the invention, as shown in FIGS. 3 and 4, the transmission source 3 is on the outer lens 6 that closes the light and comprises at least two dispersive zones, namely a first dispersive zone 10 adapted to transmit the light beam with a first aperture angle 12 and a second dispersive zone 11 adapted to transmit the light beam with a second aperture angle 13. In this invention, a greater number of zones and therefore as many corresponding functions may equally to envisaged.

Each dispersive zone corresponds to a different function of the light. For example, the first zone 10 can correspond to a fog light and the second zone 11 to a running light. However, other combinations and choices of functions of the lights are possible.

To make them dispersive, the zones 10, 11 comprise dispersive patterns distributed across the transmission face 3, for example. Accordingly, when the collimated light rays of the light beam encounter and pass through the transmission surface 3, they are dispersed in all directions. The dimensions of the dispersive patterns are chosen to provide the function of the light. Each function has to comply with regulations concerning the intensity and the projection angle of the light beam. The patterns in each zone are different so that the dispersed beam has a different aperture angle on leaving each zone. The dispersive patterns are preferably distributed uniformly across each of the two zones 10, 11 of the transmission surface 3.

As shown in FIG. 5, each has the shape of a cushion 9, for example, having a curvature, here convex, with a constant radius of curvature. The cushions 9 are substantially square, preferably with curved sides having a length 14 between 0.3 and 2 mm inclusive. FIG. 6 shows the exit face of a cushion 9 the curvature of which deflects the light rays passing through it. The deflection is effected at an angle a relative to the axis 15 of the cushion 9. The curvature of the cushion 9 is chosen as a function of the required angle α and consequently of the first and second aperture angles required. The cushions of the first and second zones have different radii of curvature, for example.

Other dispersive patterns can be used, such as holographic patterns. The holographic patterns are configured to disperse the light beam passing through the first and/or the second zone.

The device 1 further includes distribution means configured to distribute the light beam across the first dispersive zone 10 and/or the second dispersive zone 11 of the transmission surface 3. In other words, the distribution means make it possible to orient the light beam either onto the first dispersive zone 10 to produce a first function of the light or onto the second dispersive zone 11 to produce a second function of the light or alternately onto the first zone 10 and the second zone 11. In the latter case, the two zones 10, 11 are illuminated, the two functions being used simultaneously. The alternating distribution is preferably effected at a frequency imperceptible to the eye. An observer therefore has the illusion that the two zones are illuminated at the same time.

As FIG. 4 shows, the first dispersive zone 10 transmits the light beam with a first aperture angle 12 and the second dispersive zone 11 transmits the light beam with a second aperture angle 13. Each aperture angle 12, 13 corresponds to one function of the light. In this example, the first function is a fog light and the second function is a rear running light, the first aperture angle 12 being smaller than the second aperture angle 13. For a light source of constant intensity, the light beam leaving the first dispersive zone 10 is therefore more intense than that leaving the second dispersive zone 11.

In the first embodiment from FIGS. 1 and 2 using a laser, the distribution means consist of sweeping means 4 configured to sweep the transmission surface 3 with the light beam. Sweeping is accomplished at a sufficiently high speed for the human eye not to perceive the movement of the light spot over the transmission surface 3 and to observe a substantially constant and uniform illumination of the swept portion of the outer lens 6. The sweeping is effected over the selected zone 10, 11. In the case of simultaneous illumination of the two zones 10, 11 the zones are swept one after the other, either entirely or in part (for example in rows), by an iterative process. The sweeping means 4 then have a sweeping frequency sufficient both to sweep each zone individually and to go from one zone to the other without the human eye perceiving it.

For this embodiment using a laser source, the transmission surface 3 can advantageously be configured to produce sufficient dispersion of the beam in the event of a malfunction of the sweeping means 4. In fact, if sweeping is interrupted the laser beam is fixed in one direction. It is therefore necessary to ensure the safety of an observer, in particular with regard to their eyes, at least from a certain distance from the light. The dispersion is advantageously sufficient to be safe beyond a distance of approximately fifteen centimeters, for example. Of course other alternative or additional safety means may be provided to protect against malfunctions of the laser source or the sweeping system that give rise to a risk to the eyes of observers of the light.

Before impinging on the transmissive surface 3, the light beam from the light source 2 is preferably directed by the sweeping means 4 onto a first mirror 7 that reflects it toward a second mirror 8. The second mirror 8 in turn reflects the light beam toward the transmission surface 3 of the outer lens 6 of the light. The two mirrors 7, 8 serve to bend the optical path of the light beam to produce a compact light at the same time as allowing the light beam to sweep the transmission surface 3 with an angle of incidence close to the normal. FIG. 2 shows the lighting device 1 with the path of the light beam from the light source 2 to the outer lens 6.

In the example from FIGS. 1 and 2, the sweeping means 4 consist of a mobile micromirror enabling the transmission surface 3 to be swept by reflection of the light beam in a first, for example horizontal direction of the transmission surface 3. The micromirror is moved with a periodic movement produced by an actuator (not shown). The micromirror moves around a rotation axis orthogonal to the first direction in order for the light spot of the light beam to sweep the transmission surface 3 in said first direction.

If the light spot of the light beam is small and forms a light spot or patch, the sweeping means 4 are also configured to sweep the transmission surface 3 with the light beam in a second direction. The second direction is preferably substantially perpendicular to the first direction in order for the beam to move easily over the transmission surface 3.

In the embodiment from FIGS. 1 and 2, the micromirror is also configured to sweep the transmission surface 3 with the light beam in the second direction. In other words, the same micromirror sweeps the transmission surface 3 with the light beam in the two directions. The micromirror therefore performs another movement, for example of rotation about a second rotation axis perpendicular to the previous one. The micromirror therefore allows the light spot of the light beam to sweep the transmission surface 3 both horizontally and vertically.

A variant embodiment, not shown in the figures, consists in using a second micromirror to sweep the light beam in the second direction. In this case, the sweeping means 4 include two micromirrors disposed one after the other on the optical path of the beam, each having the function of sweeping the transmission surface 3 with the light beam in one of the two directions.

The micromirrors mentioned the description as constituting the sweeping means are for example of MEMS (Micro-Electro-Mechanical System) type. However, the invention is in no way limited to this kind of sweeping means and can use other sorts of sweeping means such as a series of mirrors on a rotary element, the rotation of the element causing the light beam to sweep the transmission surface.

For the second embodiment that is not shown in the figures and uses light-emitting diodes, the distribution means consist for example of a micromirror matrix of DMD (Digital Micromirror Device) type that directs the light beam by reflection. The light beam is reflected in two directions, either toward the first dispersive zone 10 or toward the second dispersive zone 11. Each micromirror can pivot between two fixed positions, a first position in which the incident light rays are reflected toward the first dispersive zone and a second position in which the incident light rays are reflected toward the second dispersive zone 10, 11. The two fixed positions are oriented in the same manner for all the micromirrors and define between them an angle characteristic of the matrix of micromirrors.

Moreover, this device can advantageously be used to display symbols, which may in particular be dynamic. The distribution means are then configured to distribute the light beam over the transmission surface in such a manner as to cause the symbol or symbols to appear.

1. A lighting device comprising two zones, intended in particular for a motor vehicle, including a transmission surface capable of transmitting light rays and at least one light source capable of emitting light rays in order to form a light beam in the direction of the transmission surface, wherein the device also comprises distribution means configured both to distribute the light beam over a first dispersive zone of the transmission surface and to distribute the light beam over a second dispersive zone of the transmission surface, the first dispersive zone being able to transmit the light beam with a first aperture angle and the second dispersive zone being able to transmit the light beam with a second aperture angle.

2. The device according to claim 1, wherein the first aperture angle and the second aperture angle have different values

3. The device according to claim 1, wherein the distribution means are configured to distribute the light beam alternately over the first zone and over the second zone at a frequency imperceptible to the eye.

4. The device according to claim 1, wherein the first disperse zone and/or the second dispersive zone include dispersive patterns.

5. The device according to claim 4, wherein the dispersive patterns have a cushion shape uniformly distributed over the transmission surface and having a curvature.

6. The device according to claim 5, wherein the curvature of the cushions has a constant radius of curvature.

7. The device according to claim 5, wherein the cushions of the first zone and of the second zone have different radii of curvature.

8. The device according to claim 1, wherein the first dispersive zone and/or the second dispersive zone include holographic patterns.

9. The device according to claim 1, wherein the distribution means are means for sweeping the transmission surface configured to sweep the transmission surface with a sweeping amplitude corresponding to the dimensions of the dispersive zone over which the beam is distributed.

10. The device according to claim 9, wherein the sweeping means include one or two mobile micromirrors configured to sweep the transmission surface with the light beam in a first direction and/or a second direction substantially perpendicular to the first direction.

11. The device according to claim 9, wherein the light source includes at least one laser diode.

12. The device according to claim 1, wherein the distribution means consist of a matrix of micromirrors.

13. The device according to claim 12, wherein the light source includes at least one light-emitting diode.

14. The device according to claim 1, wherein the light source is of constant intensity.

15. The device claim 1, wherein the device includes an optical system configured to collimate the light rays coming from the light source to form the light beam.

16. The device according to claim 1, wherein the device includes an outer lens including the transmission surface.

17. A motor vehicle light including a lighting device comprising two zones according to claim 1.

18. The device according to claim 2, wherein the distribution means are configured to distribute the light beam alternately over the first zone and over the second zone at a frequency imperceptible to the eye.

19. The device according to claim 3, wherein the first disperse zone and/or the second dispersive zone include dispersive patterns.

20. The device according to claim 6, wherein the cushions of the first zone and of the second zone have different radii of curvature.
